(19) United States
(12) Patent Application Publication
(10) Pub. No.: US 2014/0115504 A1
(43) Pub. Date: Apr. 24, 2014

(54) METHOD AND APPARATUS FOR CONFIGURING PARAMETERS UNDER BS ARCHITECTURE

(71) Applicant: Huawei Technologies Co., Ltd., Shenzhen (CN)

(72) Inventors: Wanqing Nan, Shenzhen (CN); Yanliang Ji, Shenzhen (CN); Wei Lu, Shenzhen (CN)

(73) Assignee: Huawei Technologies Co., Ltd., Shenzhen (CN)

(21) Appl. No.: 14/143,792

(22) Filed: Dec. 30, 2013

Related U.S. Application Data
(63) Continuation of application No. PCT/CN2011/078157, filed on Aug. 9, 2011.

(51) Int. Cl. G06F 3/0484

(52) U.S. Cl. CPC G06F 3/0484
USPC 715/760

(57) ABSTRACT

A method and an apparatus for configuring parameters under Browser and Server (BS) architecture are provided. The method includes: receiving a selection input which selects a source object of a first frame, in a browser window where the first frame and a second frame are displayed; generating an avatar effect entity in the second frame based on the selection input, wherein the avatar effect entity carries information of the source object; and establishing an association between a target object and the information of the source object carried by the avatar effect entity, when the avatar effect entity is moved to a position corresponding to the target object in the second frame. Based on the solution, the parameters may be configured during the cross-frame dragging under the BS architecture, thereby simplifying the user's operation steps. The operations are intuitive and natural, thereby meeting the user mental model.

### CROSS-REFERENCE TO RELATED APPLICATIONS

This application is a continuation of International Application No. PCT/CN2011/078157, filed on Aug. 9, 2011, which is hereby incorporated by reference in its entirety.

### FIELD OF THE INVENTION

The present invention relates to the field of Browser and Server (BS) architecture application, and particularly to a method and an apparatus for configuring parameters under BS architecture.

### BACKGROUND OF THE INVENTION

Currently, the WEB technology has an important position in the telecom software. In the WEB technology, the page presentation and interaction directly concern the user's experience. The direct dragging of the elements in the browser window is appreciated by more and more users due to the advantages of being rapid, intuitive and convenient. However, in case a browser window displays multiple frames, it is difficult in the industry to configure the parameters during the cross-frame dragging under the BS architecture. In which, the frames can divide one WEB browser window into several Hyper Text Markup Language (HTML) pages, and each frame is an independent HTML page.

### SUMMARY OF THE INVENTION

The embodiments of the present invention provide a method and an apparatus for configuring parameters under Browser and Server (BS) architecture, thereby simplifying the user's operation steps.

An aspect provides a method for configuring parameters under BS architecture, comprising: receiving a selection input which selects a source object of a first frame, in a browser window where the first frame and a second frame are displayed; generating an avatar effect entity in the second frame based on the selection input, wherein the avatar effect entity carries information of the source object; and establishing an association between a target object and the information of the source object carried by the avatar effect entity, when the avatar effect entity is moved to a position corresponding to the target object in the second frame.

Another aspect provides an apparatus for configuring parameters under BS architecture, comprising: a reception unit configured to receive a selection input which selects a source object of a first frame, in a browser window where the first frame and a second frame are displayed; a generation unit configured to generate an avatar effect entity in the second frame based on the selection input, wherein the avatar effect entity carries information of the source object; and an association unit configured to establish an association between the target object and the information of the source object carried by the avatar effect entity, when the avatar effect entity is moved to a position corresponding to the target object in the second frame.

Another aspect provides a method for configuring parameters based on BS architecture, comprising: representing a source parameter selection region in a first frame of a browser window, wherein the source parameter selection region comprises parameter modules; in the browser window, representing a parameter configuration region in the second frame adjacent to or separated from the source parameter selection region, wherein the parameter configuration region comprises at least one entry to be configured; and displaying a parameter display entry in the source parameter selection region and/or the parameter configuration region when a parameter module in the source parameter selection region is selected and dragged towards the parameter configuration region, and recording the parameter in the parameter display entry to the entry to be configured when the parameter display entry is moved by being dragged to be aligned and/or overlapped with the entry to be configured in the parameter configuration region.

Through the embodiments of the present invention, the parameters may be configured during the cross-frame dragging under the BS architecture, thereby simplifying the user's operation steps. The operations are intuitive and natural, thereby meeting the user mental model.

### BRIEF DESCRIPTION OF THE DRAWINGS

In order to more clearly describe the technical solutions of the embodiments of the present invention, the drawings to be used in the descriptions of the embodiments or the prior art are briefly introduced as follows. Obviously, the following drawings just illustrate some embodiments of the present invention, and a person skilled in the art can obtain other drawings from these drawings without paying a creative effort.

FIGS. 1A and 1B are flowcharts of a method for configuring parameters under BS architecture according to the embodiments of the present invention, respectively;

FIGS. 2 to 8 are schematic screenshots of a method for configuring parameters under BS architecture according to the embodiments of the present invention;

FIG. 9 is a schematic screenshot of a method for configuring parameters under BS architecture according to another embodiment of the present invention;

FIG. 10 is a block diagram of an apparatus for configuring parameters under BS architecture according to an embodiment of the present invention;

FIG. 11 is a block diagram of an apparatus for configuring parameters under BS architecture according to another embodiment of the present invention;

FIG. 12 illustrates a method for configuring parameters based on BS architecture according to another embodiment of the present invention.

### DETAILED DESCRIPTION OF THE PREFERRED EMBODIMENTS

The technical solutions of the embodiments of the present invention will be clearly and completely described as follows with reference to the drawings. Apparently, the described embodiments are just a part of embodiments of the present invention rather than all the embodiments. Based on the embodiments of the present invention, any other embodiment obtained by a person skilled in the art without paying a creative effort will fall within the protection scope of the present invention.

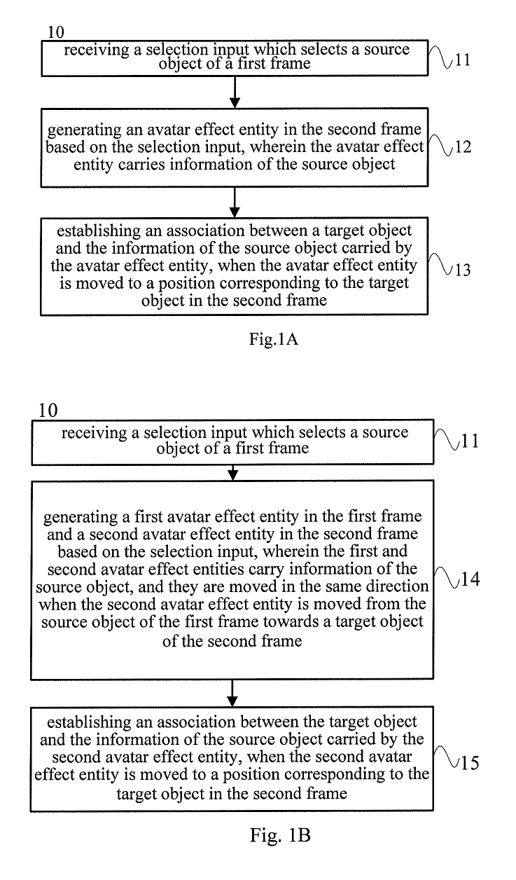

FIG. 1A is a flowchart of method 10 for configuring parameters under BS architecture according to an embodiment of the present invention.

In step 11 of FIG. 1, a selection input which selects a source object of the first frame is received in a browser window where the first frame and a second frame are displayed.

In a browser window with multiple frames, a source object is selected, and the frame where the source object is located is hereinafter referred to as the first frame. The source object may be any element carrying information in the browser window and may be selected with the mouse, such as a file, a folder, an icon, etc. The carried information may be the file content, the folder structure, the icon definition parameter, the mapping ID of the source object in the server, etc. The frame where a target object is located is hereinafter referred to as the second frame. The target object may be any element capable of receiving a mouse event in the browser window, such as a file, a folder, an icon, etc.

In step 12 of FIG. 1, an avatar effect entity is generated in the second frame based on the selection input, wherein the avatar effect entity carries information of the source object.

The information of the source object may be the content of the source object, the mapping ID of the source object in the server, etc.

In step 13 of FIG. 1, an association is established between a target object and the information of the source object carried by the avatar effect entity, when the avatar effect entity is moved to a position corresponding to the target object in the second frame.

Establishing the association between the target object and the information of the source object carried by the avatar effect entity may be storing the information of the source object carried by the avatar effect entity as information of the target object, including assignment, update, merging, etc. of the information of the target object.

Based on the solution of the above embodiment, the parameters may be configured during the cross-frame dragging under the BS architecture, thereby simplifying the user's operation steps. The operations are intuitive and natural, thereby meeting the user mental model.

Alternatively, FIG. 1B is a flowchart of method 10 for configuring parameters under BS architecture according to another embodiment of the present invention.

FIG. 1B differs from FIG. 1A in that steps 12 and 13 of FIG. 1A are replaced by steps 14 and 15 of FIG. 1B, respectively. The same reference sign denotes the same process.

In step 14 of FIG. 1, a first avatar effect entity is generated in the first frame and a second avatar effect entity is generated in the second frame based on the selection input, wherein the first and second avatar effect entities carry information of the source object, and they are moved in the same direction when the second avatar effect entity is moved from the source object of the first frame towards a target object of the second frame.

The information of the source object may be the content of the source object, the mapping ID of the source object in the server, etc.

In step 15 of FIG. 1, an association is established between the target object and the information of the source object carried by the second avatar effect entity, when the second avatar effect entity is moved to a position corresponding to the target object in the second frame.

Establishing the association between the target object and the information of the source object carried by the second avatar effect entity may be storing the information of the source object carried by the second avatar effect entity as information of the target object, including assignment, update, merging, etc. of the information of the target object.

During the representation of the page of the browser window, when the visual display of the second avatar effect entity overlaps that of the first avatar effect entity, e.g., the second avatar effect entity is superposed on the first avatar effect entity or the first avatar effect entity is hidden by the second avatar effect entity, the user visually feels that the source object in the first frame is directly selected and dragged across frames to the target object in the second frame, so the information of the target object is changed, which is actually done through corresponding change of content of the lower layer system. In that case, from the user experiences, the method of FIG. 1B is the same as that of FIG. 1A.

Based on the solution of the above embodiment, the parameters may be configured during the cross-frame dragging under the BS architecture, thereby simplifying the user's operation steps. The operations are intuitive and natural, thereby meeting the user mental model.

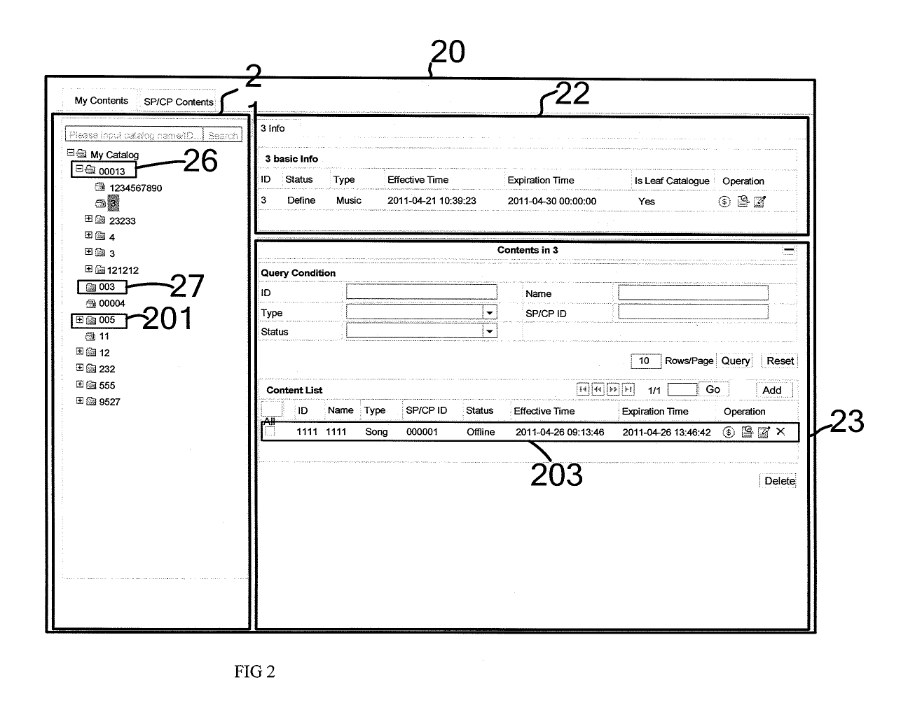

For the convenience of description, FIGS. 2 to 8 are schematic screenshots of a method for configuring parameters under BS architecture according to the embodiments of the present invention. The browser windows in the drawings are just examples, and the layouts of the frames within the same browser window and the elements therein are not limited in the embodiments of the present invention.

As illustrated in FIG. 2, a browser window 20 has multiple frames, wherein the left tree structure (hierarchy architecture) region (left tree), the upper right catalogue region and the lower right region are different frames. When the left tree frame 21 is created, the upper right frame 22 and the lower right frame 23 may be affiliated to the left tree frame 21. Now, it is required to drag the information in the lower right frame 23 to the left tree frame 21 (parent frame). The left tree includes a non-leaf catalogue 26 and a leaf catalogue 27 affiliated to the hierarchy architecture. The non-leaf catalogue 26 may include one or more non-leaf catalogues 26 and/or leaf catalogues 27. The leaf catalogue 27 is the bottom layer and no longer includes any catalogue.

The left tree frame 21 is the frame where a target object 201 is located, and referred to as the second frame. The lower right frame 23 is the frame where a source object 203 is located, and referred to as the first frame. The source object 203 may be any element carrying information in the browser window and may be selected with the mouse, such as a file, a folder, an icon, etc. The carried information may be the file content, the folder structure, the icon definition parameter, the mapping ID of the source object in the server, etc. The target object 201 may be any element capable of receiving a mouse event in the browser window, such as a file, a folder, an icon, etc. For the convenience of illustration, the source object 203 of the first frame 23 and the target object 201 of the second frame 21 are marked out.

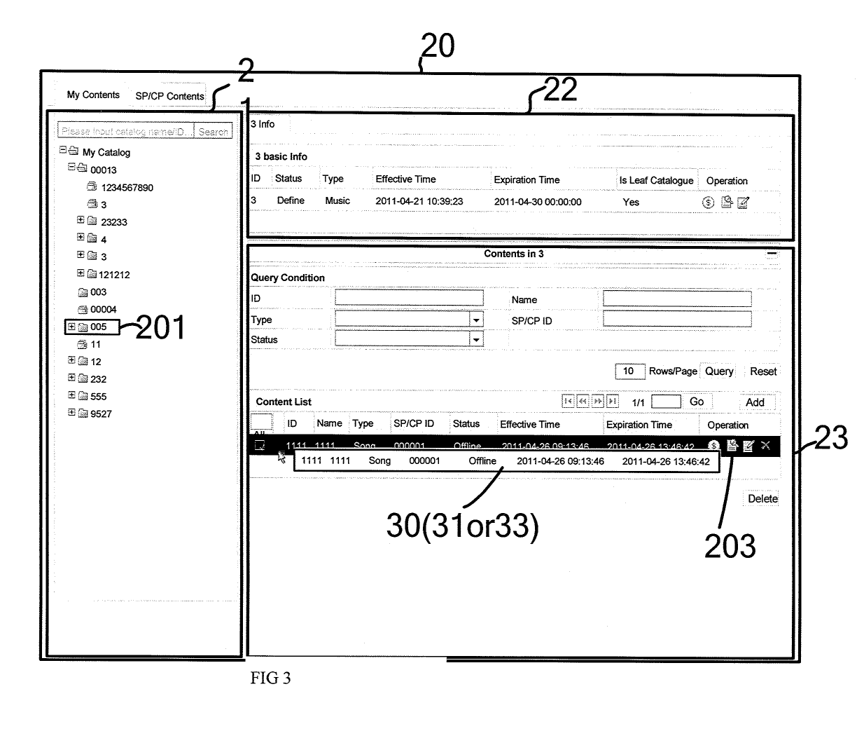

As illustrated in FIG. 3, the user selects the source object 203 of the first frame 23 with a mouse. As an apparatus of the embodiment of the present invention, a reception unit receives the selection input which selects the source object 203 of the first frame 23. Multiple pieces of information may be selected as the source object by clicking the check box. Of course, a piece of information also can be directly clicked and then dragged. And it is more convenient for the user to make a selection.

While the mouse is moved, an avatar effect entity 30 is generated in the second frame 21.

Alternatively, as an implementation of the embodiment of FIG. 1B, a first avatar effect entity 33 is generated in the first frame 23, and a second avatar effect entity 31 is generated in the second frame 21, wherein the first avatar effect entity 33 and the second avatar effect entity 31 carry the information of the source object.

One of the attributes of the browser is that each frame can only define its affiliated avatar effect entity and the information carried therein, and cannot directly employ the avatar effect entity and the information carried therein defined by any other frame.

In this embodiment, the DIV of the second avatar effect entity 31 is placed behind the current position of the mouse, and the DIV of the first avatar effect entity 33 is placed behind the DIV of the second avatar effect entity 31. The user may observe the second avatar effect entity 31 superposed on the first avatar effect entity 33, or the first avatar effect entity 33 may be hidden (e.g., being rendered to be transparent). Thus, a ghost image will not appear even the two avatar effect entities are dragged, and the user has a better experience.

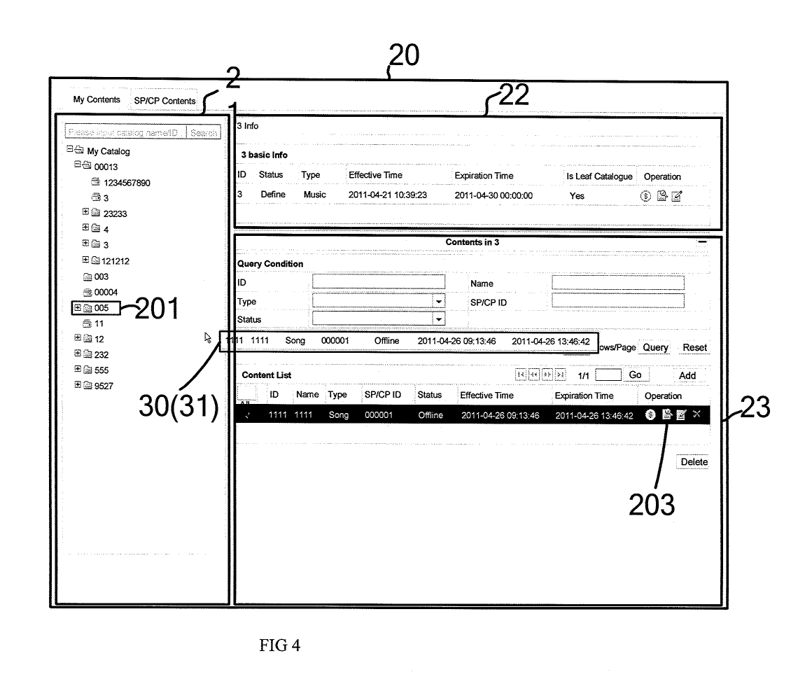

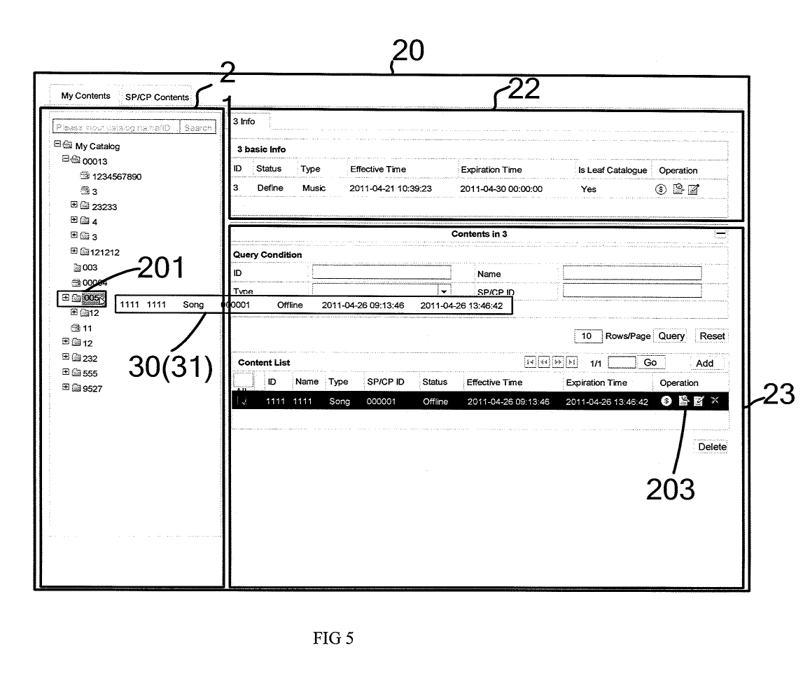

As illustrated in FIG. 4, the user 31 moves towards the target object 201 using the mouse. In that case, the mouse is moved leftwards, and the second avatar effect entity 201 and the first avatar effect entity 203 are moved in the same direction. At that time, the user visually feels that an avatar effect is moved from the source object 203 towards the target object 201, and the first avatar effect entity and the information carried therein are reserved in the first frame when the mouse crosses the first frame 23. When the first avatar effect entity is hidden, the user can only observe that the second avatar effect entity is moved leftwards. At that time, the user visually feels that an avatar effect is moved from the source object 203 towards the target object 201 across frames. The feeling is the same as that when the avatar effect entity 30 is directly dragged, which prevents dragging the mouse from different applications, and provides the user with a better experience.

As illustrated in FIG. 5, within the second frame 21, the user moves towards the target object 201 using the mouse.

As a page element capable of receiving the mouse event, the target object 201 may be the non-leaf catalogue 26, the leaf catalogue 27, or a virtual button, etc.

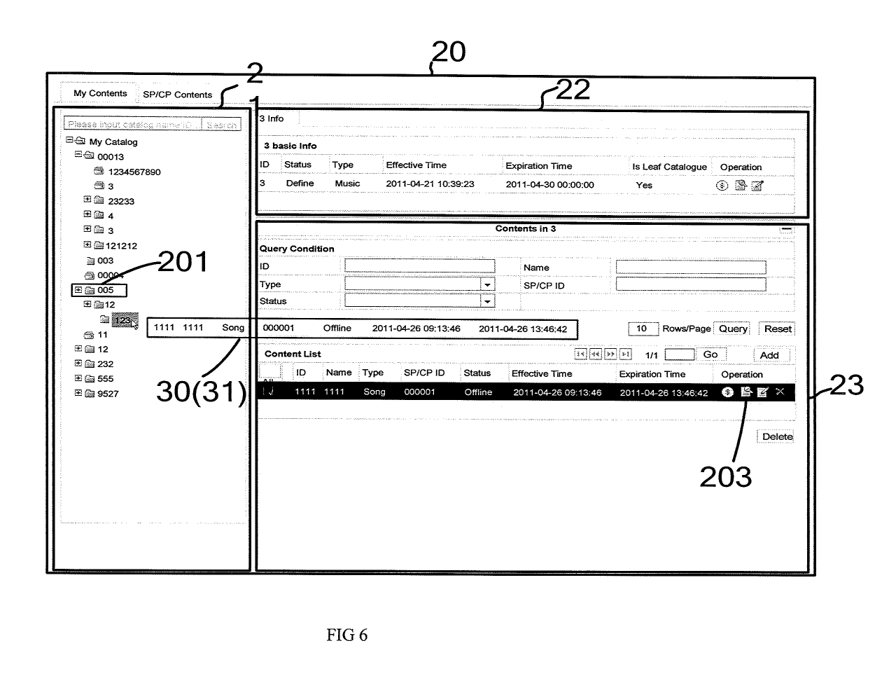

In the browser 32, as an implementation, the user moves the mouse to the target object 201, as illustrated in FIG. 6. The non-leaf catalogue 26 where the mouse passes is expanded progressively to display information corresponding to the non-leaf catalogue 26, or one or more non-leaf catalogues 26 and/or leaf catalogues 27 included therein, so that the user can select the target object more conveniently. As an example illustrated in FIG. 6, the target object 201 selected by the mouse is one of the leaf catalogue(s) 27.

In case the mouse passes other element such as the leaf catalogue or the virtual button, the hierarchy architecture needs not to be expanded.

As illustrated in FIG. 6, the user moves the mouse to the target object 201 to establish an association between the target object 201 and the information of the source object 203 carried by the avatar effect entity 30 (or the second avatar effect entity 31). When the association is successfully established, the information of the source object 203 may be stored as the information of the target object, for example, the information of the source object 203 is used for assignment, update, merging, etc. of the information of the target object 201.

The browser stores the content of the browser window into the server, for a usage next time by the user.

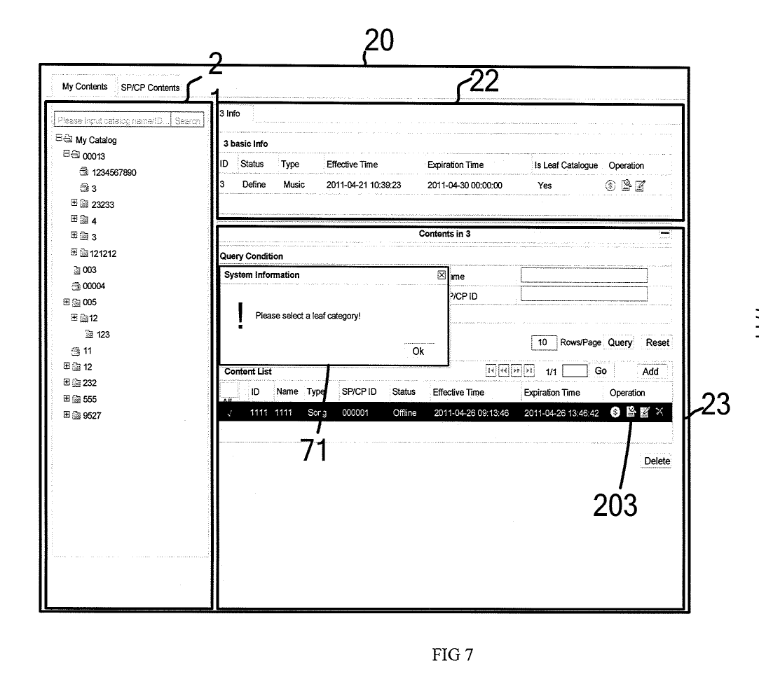

As illustrated in FIG. 7, when the mouse is moved to an object incapable of receiving the mouse event, a prompt box 71 may prompt that the cross-frame dragging is failed or may prompt a correct method for establishing the association.

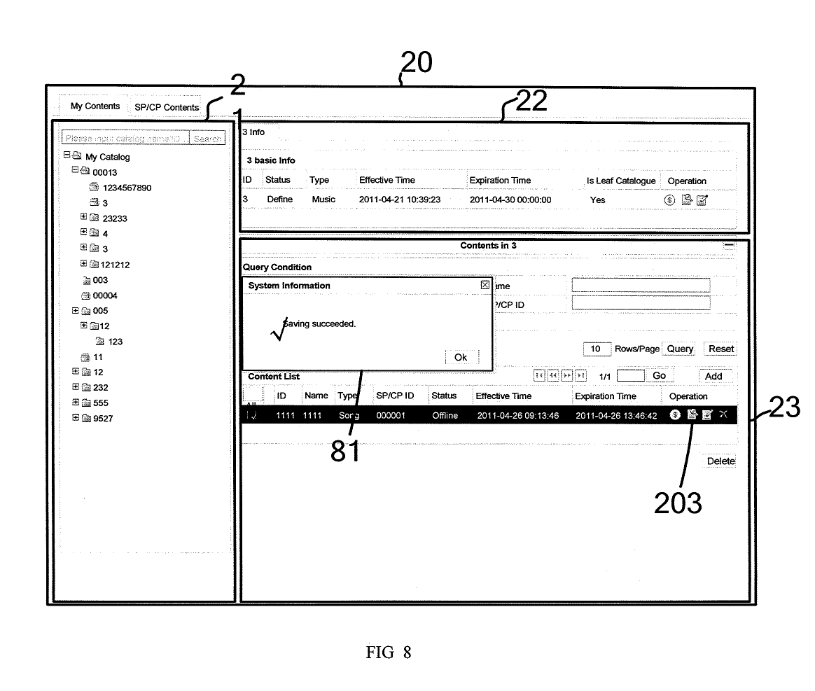

As illustrated in FIG. 8, when the association is successfully established, a prompt box 81 may indicate success information that the cross-frame dragging succeeds.

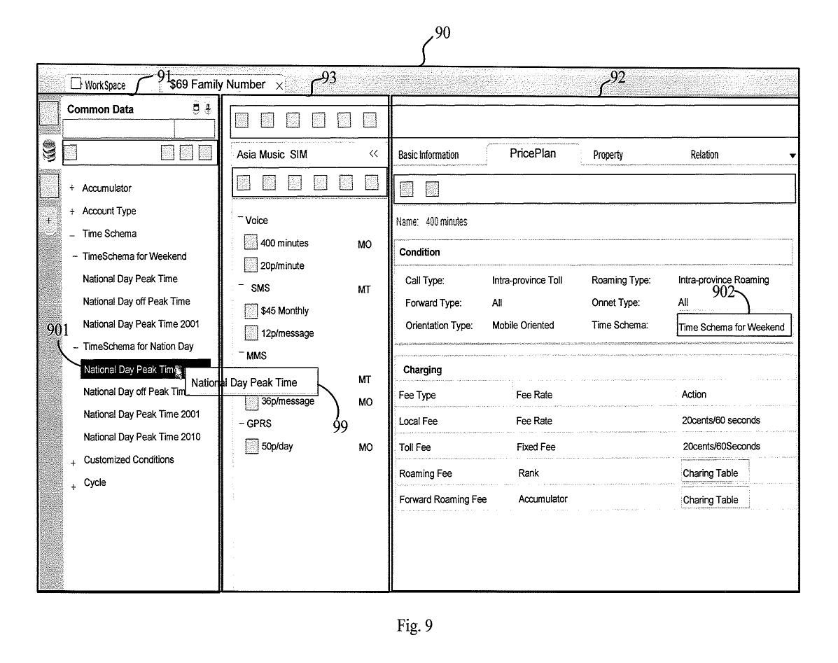

FIG. 9 is a schematic screenshot of a method for configuring parameters under BS architecture according to another embodiment of the present invention.

As illustrated in FIG. 9, the browser window 90 has three frames, i.e., a left frame (first frame) 91, an intermediate frame 93 and a right frame (second frame) 92. The icon (National Day Peak Time) in the left frame 91 is selected as a source object 901, and dragged across frames to a target object 902 (i.e., a virtual button-Time Schedule for Weekend) in the right frame 92. An avatar effect entity 99 in FIG. 9 is similar to the avatar effect entity 30 or 31 illustrated in FIG. 2. In the method according to the embodiment of the present invention, the information “National Day Peak Time” carried by the source object 901 is assigned, updated or merged into the information “Time Schedule for Weekend” of the target object 902, thus the parameters are configured by dragging the object across frames within the browser window.

The browser stores the content of the browser window into the server, for a usage next time by the user.

Based on the solution of the above embodiment, the parameters may be configured during the cross-frame dragging under the BS architecture, thereby simplifying the user's operation steps. The operations are intuitive and natural, thereby meeting the user mental model.

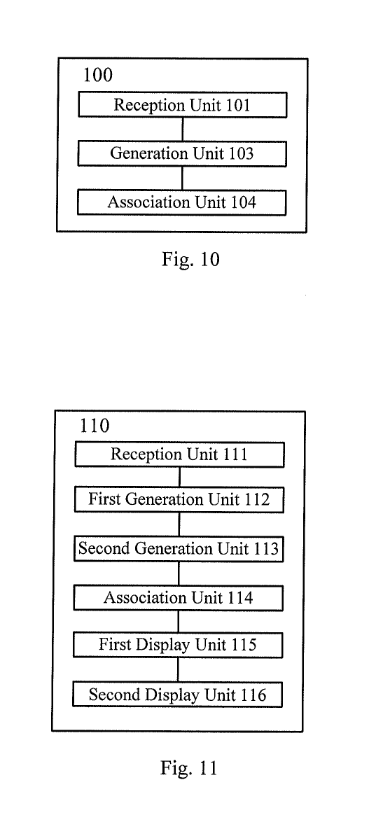

FIG. 10 is a block diagram of an apparatus 100 for configuring parameters under BS architecture according to an embodiment of the present invention.

The apparatus 100 includes a reception unit 101, a generation unit 103 and an association unit 104.

The reception unit 101 is configured to receive a selection input which selects a source object of a first frame, in a browser window where the first frame and a second frame are displayed.

In a browser window with multiple frames, a source object is selected, and the frame where the source object is located is hereinafter referred to as the first frame. The source object may be any element that carries information in the browser window and may be selected with the mouse, such as a file, a folder, an icon, etc. The carried information may be the file content, the folder structure, the icon definition parameter, the mapping ID of the source object in the server, etc. The frame where a target object is located is hereinafter referred to as the second frame. The target object may be any element capable of receiving a mouse event in the browser window, such as a file, a folder, an icon, etc.

The generation unit 103 is configured to generate an avatar effect entity in the second frame based on the selection input, wherein the avatar effect entity carries information of the source object.

The information of the source object may be the content of the source object, the mapping ID of the source object in the server, etc.

The association unit 104 is configured to establish an association between the target object and the information of the source object carried by the avatar effect entity, when the avatar effect entity is moved to a position corresponding to the target object in the second frame.

Establishing the association between the target object and the information of the source object carried by the avatar effect entity may be storing the information of the source object carried by the avatar effect entity as information of the target object, including assignment, update, merging, etc. of the information of the target object.

Based on the solution of the above embodiment, the parameters may be configured during the cross-frame dragging under the BS architecture, thereby simplifying the user's operation steps. The operations are intuitive and natural, thereby meeting the user mental model.

FIG. 11 is a block diagram of an apparatus 110 for configuring parameters under BS architecture according to another embodiment of the present invention.

A reception unit 111, a second generation unit 113 and an association unit 114 of the apparatus 110 are the same as or similar to the reception unit 101, the generation unit 103 and the association unit 104 of the apparatus 100. The difference lies in that the apparatus 110 further includes a first generation unit 112, a first display unit 115 and a second display unit 116.

The first generation unit 112 is configured to generate a first avatar effect entity in the first frame based on the selection input.

The second generation unit 113 is configured to generate a second avatar effect entity in the second frame based on the selection input, wherein the first and second avatar effect entities carry information of the source object, and they are moved in the same direction when the second avatar effect entity is moved from the source object of the first frame towards a target object of the second frame.

The association unit 114 is configured to establish an association between the target object and the information of the source object carried by the second avatar effect entity, when the second avatar effect entity is moved to a position corresponding to the target object in the second frame.

Establishing the association between the target object and the information of the source object carried by the second avatar effect entity may be storing the information of the source object carried by the second avatar effect entity as information of the target object, including assignment, update, merging, etc. of the information of the target object.

The first display unit 115 is configured to superpose the second avatar effect entity on the first avatar effect entity, or hide the first avatar effect entity. The first display unit 115 is further configured to hide the first avatar effect entity and just display the second avatar effect entity, when the second avatar effect entity is moved out of the first frame.

During the representation process of the page of the browser window, when the visual display of the second avatar effect entity overlaps that of the first avatar effect entity, e.g., the second avatar effect entity is superposed on the first avatar effect entity or the first avatar effect entity is hidden, the user visually feels that the source object in the first frame is directly selected and dragged across frames to the target object in the second frame, so the information of the target object is changed, which is actually done through corresponding change of content of the lower layer system.

The second display unit 116 is configured to progressively expand any passed non-leaf catalogue when the second avatar effect entity is moved towards the target object, so as to display information corresponding to the non-leaf catalogue, or display one or more non-leaf catalogues and/or leaf catalogues included therein.

The server stores the content of the browser window after the association is established between the target object and the information of the source object carried by the second avatar effect entity.

The apparatus 110 may implement method 10. For the details, please see FIGS. 2 to 9, and herein are omitted.

Based on the solution of the above embodiment, the parameters may be configured during the cross-frame dragging under the BS architecture, thereby simplifying the user's operation steps. The operations are intuitive and natural, thereby meeting the user mental model.

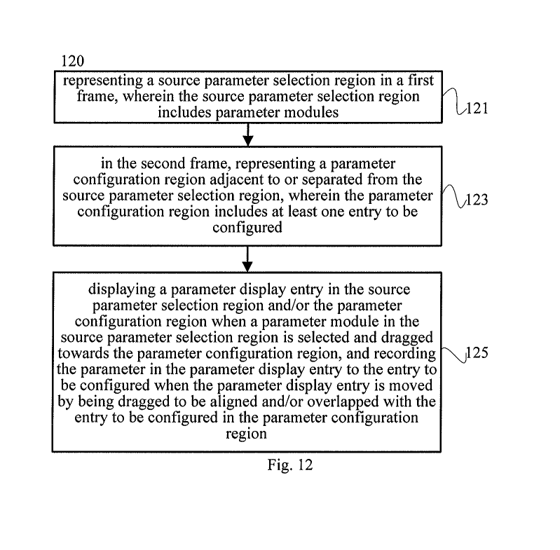

FIG. 12 illustrates a method for configuring parameters based on BS architecture according to another embodiment of the present invention. The method 120 for configuring parameters includes the following steps.

Step 121: representing a source parameter selection region in a first frame of a browser window, wherein the source parameter selection region includes parameter modules.

The browser window may be similar to the browser windows of method 10 (20 in FIG. 2 to 8 or 90 in FIG. 9), respectively, and the source parameter selection region may be similar to the first frame of method 10 (23 in FIG. 2 to 8 or 91 in FIG. 9).

The parameter module may be any element that carries information and is capable of receiving a mouse input in the source parameter selection region, i.e., it is similar to the source object of method 10 (203 in FIG. 2 to 8 or 901 in FIG. 9). Among the parameter modules, those with the same or associated attributes may be represented in the form of a hierarchy architecture.

Step 123: in the browser window, representing a parameter configuration region in the second frame adjacent to or separated from the source parameter selection region, wherein the parameter configuration region includes at least one entry to be configured.

The parameter configuration region may be similar to the second frame of method 10 (21 in FIG. 2 to 8 or 92 in FIG. 9).

The entry to be configured may be any element capable of receiving a mouse event in the browser window, such as a file, a folder, an icon, etc., and it is similar to the target object of method 10 (201 in FIG. 2 to 8 or 902 in FIG. 9).

When the entry to be configured is affiliated to the hierarchy architecture, and a parameter display entry is moved from the parameter module towards the entry to be configured, the hierarchy architecture to which the target object is affiliated will be expanded progressively until the entry to be configured is represented.

The hierarchy architecture to which the entry to be configured is affiliated may be similar to the hierarchy architecture including the non-leaf catalogue (e.g., 26 in FIG. 2) and/or the leaf catalogue (e.g., 27 in FIG. 2) and corresponding information.

Step 125: displaying a parameter display entry in the source parameter selection region and/or the parameter configuration region when a parameter module in the source parameter selection region is selected and dragged towards the parameter configuration region, and recording the parameter in the parameter display entry to the entry to be configured when the parameter display entry is moved by being dragged to be aligned and/or overlapped with the entry to be configured in the parameter configuration region.

The parameter display entry may be similar to the avatar effect entity of method 10 (30 or 31 in FIG. 2 to 8 or 99 in FIG. 9). The parameter display entry may be moved from the source parameter selection region to the entry to be configured in the parameter configuration region by means of being copied, cut or dragged.

The orders of steps 121 and 123 in FIG. 12 may be interchanged depending on different implementations, and herein are not limited.

Based on the solution of the above embodiment, the parameters may be configured during the cross-frame dragging under the BS architecture, thereby simplifying the user's operation steps. The operations are intuitive and natural, thereby meeting the user mental model.

A person skilled in the art may appreciate that the units and algorithm steps of various examples described in conjunction with the embodiments disclosed herein can be implemented by the electronic hardware, or a combination of the computer software and the electronic hardware. Whether the functions are performed by hardware or software depends on the specific applications and the design constraints of the technical solutions. A professional person may employ a different method to implement the described function with respect to each specific application, and the implementation shall not be deemed as going beyond the scope of the present invention.

A person skilled in the art can clearly know that in order to be convenient and concise, the detailed working processes of the aforementioned system, apparatus and units are omitted herein, and please see corresponding processes in the above method embodiments for the details.

In the embodiments provided by the present application, it shall be appreciated that the disclosed system, apparatus and method may be implemented in other ways. For example, the aforementioned apparatus embodiments are just exemplary. For example, the division of the units is just a logical function division, and other division mode may be employed in the actual implementation. For example, multiple units or components may be combined or integrated to another system, or some features may be omitted, or they are not executed. Another point is that the displayed or discussed mutual coupling, direct coupling or communication connection may be the indirect coupling or communication connection through some interfaces, apparatuses or units, and may be in the form of electrical, mechanical, etc.

The units described as separate parts may be or may be not physically separated. The parts displayed as units may be or may be not physical units, and may be located at the same place or distributed to multiple network units. Some or all of the units may be selected upon actual demand to implement the object of the solution of the embodiment.

In addition, various functional units in the embodiments of the present invention may be integrated into one processing unit, or existed as individual physical units, or more than two units may be integrated into one unit.

In case being implemented in the form of software function units and sold or used as independent products, the functions may be stored in a computer readable access medium. Based on such understanding, the technical solutions of the present invention substantively, or a part thereof making a contribution to the prior art, may be reflected in the form of software product stored in a storage medium, including several instructions to enable a computer device (e.g., personal computer, server, network facility, etc.) to execute all or a part of the steps of the methods of respective embodiments. The storage medium includes various mediums capable of storing program codes, such as U-disk, mobile hard disk, Read-Only Memory (ROM), Random Access Memory (RAM), magnetic disc, optical disc, etc.

The above descriptions are just some embodiments of the present invention, and the protection scope of the present invention is not limited thereto. Any change or replacement that can be easily conceived by a person skilled in the art within the technical scope disclosed by the present invention shall be covered by the protection scope of the present invention. Therefore, the protection scope of the present invention shall be determined by the protection scope of the claims.

What is claimed is:

1. A method for configuring parameters under Browser and Server (BS) architecture, comprising:
receiving a selection input which selects a source object of a first frame, in a browser window where the first frame and a second frame are displayed;
generating an avatar effect entity in the second frame based on the selection input, wherein the avatar effect entity carries information of the source object; and
establishing an association between a target object and the information of the source object carried by the avatar effect entity, when the avatar effect entity is moved to a position corresponding to the target object in the second frame.

2. The method according to claim 1, further comprising:
when the target object is affiliated to a hierarchy architecture and the avatar effect entity is moved from the source object towards the target object, progressively expanding the hierarchy architecture to which the target object is affiliated until the target object is represented.

3. The method according to claim 1, wherein establishing the association between the target object and the information of the source object carried by the avatar effect entity, when the avatar effect entity is moved to the position corresponding to the target object in the second frame comprises:
storing, by the target object, the information of the source object after establishing the association between the target object and the information of the source object carried by the avatar effect entity, when the avatar effect entity is moved to the position corresponding to the target object in the second frame.

4. An apparatus for configuring parameters under Browser and Server (BS) architecture, comprising: a reception unit configured to receive a selection input which selects a source object of a first frame, in a browser window where the first frame and a second frame are displayed;
a generation unit configured to generate an avatar effect entity in the second frame based on the selection input, wherein the avatar effect entity carries information of the source object; and
an association unit configured to establish an association between a target object and the information of the source object carried by the avatar effect entity, when the avatar effect entity is moved to a position corresponding to the target object in the second frame.

5. The apparatus according to claim 4, further comprising:
a display unit configured to progressively expand, when the target object is affiliated to a hierarchy architecture and the avatar effect entity is moved from the source object towards the target object, the hierarchy architecture to which the target object is affiliated until the target object is represented.

6. The apparatus according to claim 4, wherein, the association unit is specifically configured to establish the association between the target object and the information of the source object carried by a second avatar effect entity, when the second avatar effect entity is moved to the position corresponding to the target object in the second frame, wherein the target object stores the information of the source object.

7. A method for configuring parameters based on Browser and Server (BS) architecture, comprising:
representing a source parameter selection region in a first frame of a display interface, wherein the source parameter selection region comprises parameter modules;
representing, in the display interface, a parameter configuration region in the second frame adjacent to or separated from the source parameter selection region, wherein the parameter configuration region comprises at least one entry to be configured; and
displaying a parameter display entry in the source parameter selection region and/or the parameter configuration region when a parameter module in the source parameter selection region is selected and dragged towards the parameter configuration region, and recording the parameter in the parameter display entry to the entry to be configured when the parameter display entry is moved by being dragged to be aligned and/or overlapped with the entry to be configured in the parameter configuration region.

8. The method for configuring parameters according to claim 7, wherein among the parameter modules, those having the same or associated attributes are represented in the form of a hierarchy architecture.

9. The method for configuring parameters according to claim 7, wherein,
when the entry to be configured is affiliated to a hierarchy architecture, and the parameter display entry is moved from the parameter module towards the entry to be configured, progressively expanding the hierarchy architecture to which the target object is affiliated until the entry to be configured is represented.

10. The method for configuring parameters according to claim 8, wherein,
when the entry to be configured is affiliated to a hierarchy architecture, and the parameter display entry is moved from the parameter module towards the entry to be configured, progressively expanding the hierarchy architecture to which the target object is affiliated until the entry to be configured is represented.

11. The method for configuring parameters according to claim 7, wherein the parameter display entry is moved from the source parameter selection region to the entry to be configured in the parameter configuration region by means of being copied, cut or dragged.

12. The method for configuring parameters according to claim 8, wherein the parameter display entry is moved from the source parameter selection region to the entry to be configured in the parameter configuration region by means of being copied, cut or dragged.

13. The method for configuring parameters according to claim 9, wherein the parameter display entry is moved from the source parameter selection region to the entry to be configured in the parameter configuration region by means of being copied, cut or dragged.

14. The method for configuring parameters according to claim 10, wherein the parameter display entry is moved from the source parameter selection region to the entry to be configured in the parameter configuration region by means of being copied, cut or dragged.
